(19) United States
(12) Patent Application Publication
(10) Pub. No.: US 2021/0308754 A1
(43) Pub. Date: Oct. 7, 2021

(54) METHOD FOR PRODUCING RARE-EARTH MAGNET POWDER

(71) Applicant: AICHI STEEL CORPORATION, Aichi-ken (JP)

(72) Inventors: Masao YAMAZAKI, Aichi-ken (JP); Satoshi SUGIMOTO, Miyagi-ken (JP)

(73) Assignee: AICHI STEEL CORPORATION, Aichi-ken (JP)

(21) Appl. No.: 17/260,648

(22) PCT Filed: Jul. 17, 2019
(86) PCT No.: PCT/JP2019/028019

§ 371 Date: Jan. 15, 2021

(30) Foreign Application Priority Data
Jul. 19, 2018 (JP) 2018-136209

(51) Int. Cl. B22F 1/00; H01F 1/057; C22C 38/12; C22C 38/00

(52) U.S. Cl. CPC B22F 1/0088; H01F 1/0571; C22C 38/12; B22F 2301/355; C22C 38/002; C22C 2202/02; C22C 38/005

(57) ABSTRACT

A method for producing rare-earth magnet powder having high magnetic properties including a disproportionation step of causing hydrogen absorption and disproportionation reaction to a magnet raw material obtained by exposing a cast alloy containing a rare earth element (R), boron (B) and a transition metal (TM) to a hydrogen atmosphere having a temperature of 350 to 550 deg. C, and a recombination step of causing hydrogen desorption and recombination reaction to the magnet raw material after the disproportionation step.

### TECHNICAL FIELD

The present invention relates to a method for producing rare-earth magnet powder for use in bonded magnets, etc.

### BACKGROUND ART

Bonded magnets shaped by combining rare-earth magnet powder with a binder resin have good formability and exhibit high magnetic properties. Therefore, the bonded magnets are widely used in electromagnetic devices such as electric appliances and automobiles, which are expected to save energy and be reduced in weight. To promote the use of the bonded magnets, an improvement has been desired in magnetic properties of rare-earth magnet powder. Under these circumstances, a variety of proposals have been made in connection with hydrogen treatment during a process of producing the rare-earth magnet powder, and some related descriptions are found in the patent literature below.

It is to be noted that hydrogen treatment mainly comprises a disproportionation reaction caused by hydrogen absorption (Hydrogeneration-Disproportionation/also simply called “HD reaction”), and a recombination reaction caused by hydrogen desorption (Desorption-Recombination/also simply called “DR reaction”). A combination of HD reaction and DR reaction is simply called “HDDR reaction”, and this hydrogen treatment is called “HDDR (treatment)”. HDDR in the present description includes d-HDDR (dynamic Hydrogeneration-Disproportionation-Desorption-Recombination) as an improvement of HDDR, unless otherwise specified.

### CITATION LIST

### Patent Literature

[PTL1] JP3871219B

[PTL2] JP2008-127648A

[PTL3] JP2008-305908A

### SUMMARY OF INVENTION

### Technical Problem

PTL 1 discloses that an anisotropic rare-earth magnet powder having high magnetic properties can be obtained by applying d-HDDR including a low-temperature hydrogeneration step (room temperature, 100 kPa), a high-temperature hydrogeneration step, a structure stabilization step and a controlled evacuation step to a magnet raw material having an average particle diameter of 10 mm or less prepared by mechanically pulverizing an ingot by a jaw crusher.

PTL 2 mentions that an anisotropic rare-earth magnet powder having high magnetic properties can be obtained by HDDR treatment in which a raw material alloy having absorbed hydrogen (150 deg. C, 250 kPa) beforehand undergoes a temperature increase and hydrogen introduction, thereby slowing down HD reaction rate.

PTL 3 describes hydrogen decrepitation of a raw material alloy (about 300 deg. C, 130 kPa). PTL 3, however, relates to sintered magnets, but not to bonded magnets.

The present invention has been made under these circumstances. It is an object of the present invention to provide an unconventional method for producing rare-earth magnet powder having high magnetic properties suitable for bonded magnets.

### Solution to Problem

The present inventors have earnestly studied to solve this problem and newly founded that rare-earth magnet powder having higher magnetic properties than the conventional can be obtained by applying HDDR (including d-HDDR) to a magnet raw material obtained by applying hydrogen treatment (hydrogen decrepitation) to a cast alloy under predetermined conditions. The present inventors have conducted further research on this finding and achieved the present invention below.

### Method for Producing Rare-Earth Magnet Powder

(1) The present invention is a method for producing rare-earth magnet powder, comprising a disproportionation step of causing hydrogen absorption and disproportionation reaction to a magnet raw material obtained by exposing a cast alloy containing a rare earth element (referred to as “R”), boron (B) and a transition metal (referred to as “TM”) to a hydrogen atmosphere having a temperature within the range of 350 to 585 deg. C, and a recombination step of causing hydrogen desorption and recombination reaction to the magnet raw material after the disproportionation step.

(2) According to the production method of the present invention, rare-earth magnet powder having high magnetic properties can be obtained by applying HDDR to a magnet raw material obtained by exposing a cast magnet alloy (a cast alloy) to a hydrogen atmosphere in a higher temperature range than the conventional. Although the reason is not clear, a mechanism assumed so far will be described later.

It is to be noted that regardless of what condition (a lump shape, a particle shape, a powder shape, etc.) a magnet raw material to be supplied to HDDR is in, a treatment to expose a cast alloy to a hydrogen atmosphere in order to obtain the magnet raw material is simply referred to as “hydrogen decrepitation” in the present description. The cast alloy subjected to hydrogen decrepitation is usually easy to break down and, upon slight force application, disintegrated to take coarse lump or particle shapes. The magnet raw material can be supplied to HDDR either while kept in a coarse state or after pulverized into smaller particles.

### Magnet Raw Material, Rare-Earth Magnet Powder, Compound, Bonded Magnet

The present invention can be grasped as a magnet raw material (a powdery magnet raw material will also be referred to as “raw material powder”) obtained by hydrogen decrepitation or magnet powder obtained by the aforementioned production method. The present invention can also be grasped as a bonded magnet comprising rare-earth magnet powder and a resin for binding the powder particles. Furthermore, the present invention can also be grasped as a compound for use in producing the bonded magnet. Such a compound is formed by attaching a binder resin on surfaces of the powder particles beforehand. Magnet powder for use in bonded magnets or compounds can be composite powder including a mixture of a plurality of kinds of powders having different average particle diameters, alloy compositions, or the like.

### Others

(1) The rare-earth magnet powder according to the present invention is preferably an anisotropic magnet powder having higher magnet properties, though it can be isotropic magnet powder. The anisotropic magnet powder comprises magnet particles having greater magnetic flux density (Bᵣ) in one direction (an easy axis direction of magnetization or a c-axis direction) than those in other directions. Whether a magnetic material is isotropic or anisotropic is determined by Degree of Texture (DOT) obtained when a magnetic field is applied in parallel (∥) to and perpendicularly (⊥) to the c-axis direction (DOT=[Bᵣ(∥)−Bᵣ(⊥)]/Bᵣ(∥). If the value of DOT is 0, the magnetic material is isotropic and if the value of DOT is greater than 0, the magnetic material is anisotropic.

(2) “R” in the present description is mostly Nd, although it can be at least one of Y, lanthanoids, and actinoids. TM is mostly Fe, although it can be at least one of 3d transition elements (Sc to Cu) and 4d transitional elements (Y to Ag) or any one of Group 8 to Group 10 elements (especially Fe, Co, Ni). Part of B can be replaced with C.

The magnet raw material or the magnet powder can contain a reforming element, which is effective in improving properties, and/or (inevitable) impurities. Examples of the reforming element include Cu, Al, Ti, V, Cr, Ni, Zn, Ga, Zr, Nb, Mo, Sn, Hf, Ta, W, Dy, Tb and Co, which are effective in improving coercivity.

(3) A range “x to y” in the present description includes the lower limit value x and the upper limit value y, unless otherwise particularly specified. A new range, such as “a to b” can be formed by using any of the various values or any arbitrary value within the various numerical ranges in the present description as a new lower limit value or a new upper limit value. In addition, “x to y kPa” means x kPa to y kPa. The same applies to other units.

### BRIEF DESCRIPTION OF DRAWINGS

FIG. 1A is a flow chart showing a production process of magnet powder.

FIG. 1B is a chart showing a hydrogen atmosphere used in hydrogen decrepitation.

FIG. 1C is a chart showing another pattern of a hydrogen atmosphere used in hydrogen decrepitation.

FIG. 2 shows SEM images of outer surfaces of magnet raw materials (raw material clumps) obtained by hydrogen decrepitation under different conditions.

FIG. 3A comparatively shows SEM images of outer surfaces and cross sections of magnetic raw material particles obtained by hydrogen decrepitation at different atmosphere temperatures.

FIG. 3B is a scatter plot showing a relation between hydrogen decrepitation temperature and average particle diameters of raw material powders.

FIG. 4A comparatively shows SEM images of outer surfaces and cross sections of powders (magnet powders) obtained by applying d-HDDR to raw material powders obtained by hydrogen decrepitation at different atmosphere temperatures.

FIG. 4B is a scatter plot showing a relation between hydrogen decrepitation temperature of the raw material powders and average particle diameters of magnet powders.

FIG. 5A is a scatter plot showing a relation between hydrogen decrepitation temperature of raw material powders and maximum energy product of magnet powders.

FIG. 5B is a scatter plot showing a relation between hydrogen decrepitation temperature of the raw material powders and residual magnetic flux density of the magnet powders.

FIG. 5C is a scatter plot showing a relation between hydrogen decrepitation temperature of the raw material powders and coercivity of the magnet powders.

FIG. 6 is a scatter plot showing a relation between hydrogen decrepitation temperature and crack density.

FIG. 7 is a diagram for explaining a mechanism of how cracks occur in a main phase and/or a grain boundary phase.

FIG. 8A is a scatter plot showing a relation between dispersion treatment temperature of casting products and maximum energy product of magnet powders.

FIG. 8B is a scatter plot showing a relation between dispersion treatment temperature of the casting products and residual magnetic flux density of the magnet powders.

FIG. 8C is a scatter plot showing a relation between dispersion treatment temperature of the casting products and coercivity of the magnet powders.

FIG. 9A is a scatter plot showing maximum energy product of magnet powders obtained by applying HDDR treatment in succession to hydrogen decrepitation.

FIG. 9B is a scatter plot showing residual magnetic flux density of those magnet powders.

FIG. 9C is a scatter plot showing coercivity of those magnet powders.

### DESCRIPTION OF EMBODIMENTS

One or more constituent elements selected freely from those stated in the present description can be added to the abovementioned constituent elements of the present invention. What is stated in the present description appropriately applies not only to the production method of the present invention but also a magnet raw material, rare-earth magnet powder, a compound, a bonded magnet, etc., and a constituent element of the production method can be that of a product. Which embodiment is the best is different depending on application targets, required performance, and the like.

### Magnet Raw Material

### (1) Cast Alloy

A cast alloy can be an ingot alloy obtained by pouring a molten R-TM-B based alloy into a mold and solidifying the molten alloy or a rapidly solidified alloy obtained by rapidly solidifying the molten alloy. The rapidly solidified alloy can be obtained, for example, by strip casting etc.

Preferably, the cast alloy comprises a casting product subjected to solution treatment (step) before hydrogen decrepitation. Since the ingot alloy solidifies slowly, i.e., at a low cooling rate, a soft magnetic αFe phase tends to precipitate (survive). When solution treatment is applied to the ingot alloy, the αFe phase disappears, so segregation etc. is removed and a homogeneous structure is obtained in which fine crystal grains have grown (e.g., crystal grain diameter: 50 to 250 μm).

Since the rapidly solidified alloy solidifies more rapidly, i.e., at a higher cooling rate than the ingot alloy, the soft magnetic αFe phase hardly precipitates (hardly survives), or finely precipitates only in a very small amount. Therefore, the rapidly solidified alloy has a relatively homogeneous crystal structure when compared to the ingot alloy. Upon application of solution treatment, the rapidly solidified alloy attains a structure in which mainly fine crystal grains have grown (e.g., crystal grain diameter: 50 to 250 μm).

The solution treatment of the ingot alloy and that of the rapidly solidified alloy do not have entirely the same purpose. The solution treatments of both the alloys, however, have a common goal of obtaining a desired metal structure of a cast alloy before hydrogen decrepitation. Note that the solution treatment is also called homogenization heat treatment, whenever appropriate.

Preferably, the solution treatment is performed by heating the cast alloy before hydrogen decrepitation in a treatment furnace (a heating furnace) at a temperature of 1,050 to 1,250 deg. C or 1,100 to 1,200 deg. C. Preferred treatment time is, for example, 3 to 50 hours or 10 to 40 hours. A preferred treatment atmosphere is an inert atmosphere (an inert gas atmosphere such as Ar or a vacuum atmosphere).

Additionally, heat treatment called “R-rich dispersion treatment” can be applied by heating the cast alloy (the casting product) after the solution treatment in a temperature range lower than the solution treatment temperature and higher than a treatment temperature of hydrogen decrepitation to be mentioned later. Preferred temperature of this heat treatment is, for example, 650 to 900 deg. C, 650 to 800 deg. C or 680 to 750 deg. C. Preferred time for this heat treatment is, for example, 10 minutes to 10 hours or 0.5 to 3 hours. A preferred treatment atmosphere of this heat treatment is, for example, an inert atmosphere (an inert gas (such as Ar) atmosphere or a vacuum atmosphere). The R-rich dispersion treatment promotes dispersion (distribution) of a rare earth element “R” along boundaries of crystal grains of the cast alloy, thereby uniformly covering each of the crystal grains of the cast alloy with a R-rich phase. It is believed that when hydrogen decrepitation treatment is applied to such a cast alloy, fracture (separation) occurs preferentially along the crystal grain boundaries of the cast alloy and a magnet raw material having little cracking within crystal grains is easily obtained.

### (2) Alloy Composition

A tetragonal compound constituting a R₂TM₁₄B₁ based crystal (a main phase) has a theoretical composition of 11.8 at. % R, 5.9 at. % B, and a remainder of TM by atomic percent (at. %). A cast alloy having a richer R content than the theoretical composition is preferred, because it is effective in obtaining favorable particle size distribution after hydrogen decrepitation and enhancing coercivity of rare-earth magnet powder. Therefore, preferably the cast alloy contains 11 to 15 at. % R or more preferably 12 to 13 at. % R and 5 to 9 at. % or more preferably 6.2 to 7 at. % B when a total weight of the cast alloy is taken as 100 at. %.

### (3) Hydrogen Decrepitation (Step)

A magnet raw material is obtained by applying a predetermined hydrogen treatment (raw material hydrogen treatment) to the abovementioned cast alloy. This treatment (hydrogen decrepitation or hydrogen pulverization) can be performed by exposing the cast alloy placed in a treatment furnace to a hydrogen atmosphere having a temperature within the range of 350 to 585 deg. C, 400 to 575 deg. C or 425 to 550 deg. C (a hydrogen absorption step). This atmosphere temperature is a temperature for holding the cast alloy at an almost constant temperature. As long as the atmosphere temperature falls within a predetermined range, hydrogen partial pressure can be either high or low. In view of efficiency and safety in applying hydrogen decrepitation, however, the hydrogen partial pressure preferably falls within the range of 1 kPa to 250 kPa or 5 kPa to 150 kPa.

Hydrogen decrepitation is performed, for example, by evacuating a treatment furnace in which the cast alloy is placed into vacuum and then introducing hydrogen into the treatment furnace. A gas to be introduced into the treatment furnace can be hydrogen gas either alone or in a combination with an inert gas. The latter is preferred in view of easier control of hydrogen partial pressure. The gas to be introduced into the treatment furnace can keep flowing. Preferably, hydrogen decrepitation is carried out, for example, for 0.5 to 10 hours or 1 to 5 hours after an atmosphere temperature reaches a target temperature. Preferably, the hydrogen introduction into the treatment furnace is performed after the atmosphere temperature (or temperature of the cast alloy) reaches a predetermined value.

Due to hydrogen absorption, the cast alloy exposed to the hydrogen atmosphere spontaneously breaks down or is disintegrated by slight force application into lumps of about several centimeters to several millimeters in maximum length. Such a magnet raw material is referred to as “raw material lumps”. The raw material lumps obtained after hydrogen decrepitation can be separately disintegrated or pulverized into powder (raw material powder) having a particle diameter (a maximum particle diameter) of about 100 μm to 1 mm and supplied as a magnet raw material to a next step (HDDR). The magnet raw material to be subjected to HDDR can either store absorbed hydrogen or have released absorbed hydrogen. Note that although it is difficult to clearly distinguish “disintegration” and “pulverization”, let it suffice to say that intentional size reduction of particles by applying shear force is “pulverization” and breaking down of lumps by applying slight impact, etc. is “disintegration”.

When production of a magnet raw material (hydrogen decrepitation treatment) and that of magnet powder (HDDR treatment) are not performed successively, a magnet raw material having released absorbed hydrogen can be supplied to HDDR. Insertion of a hydrogen release step prevents degradation of the magnet raw material before HDDR. The hydrogen release step can be performed, for example, by causing the magnet raw material to release hydrogen at the same temperature as that of hydrogen absorption (350 to 585 deg. C) and then decreasing temperature to about room temperature (R.T.).

### (4) Supply Form to HDDR

A main object of hydrogen decrepitation of the present invention is not disintegration or particle size reduction of the cast alloy itself. An object of the present invention is to suppress cracking in crystal grains (single crystal grains) which constituted the cast alloy as much as possible. When a cast alloy is exposed to a high-temperature hydrogen atmosphere as in hydrogen decrepitation of the present invention, hydrogen hardly penetrates into crystal grains and mainly penetrates into a grain boundary phase (a R-rich phase/a Nd-rich phase) located between crystal grains (along crystal grain boundaries). As a result, cracks caused by volume expansion of the grain boundary phase in association with hydrogen penetration occur preferentially along the crystal grain boundaries. This is believed to be how the cast alloy after hydrogen decrepitation becomes a magnetic raw material comprising crystal grains with little cracking. It is estimated that, as a result that such a magnet raw material comprising crystal grains with little cracking is supplied to HDDR, magnet powder having high magnetic properties can be obtained. The cast alloy after hydrogen decrepitation (the magnet raw material) can be either particles comprising the aforementioned crystal grain simple substance (single crystal particles) or aggregates of the single crystal particles (polycrystalline particles). The aforementioned raw material lumps generally comprise polycrystalline particles.

Therefore, the magnet raw material obtained by applying hydrogen decrepitation to the cast alloy can be supplied directly to HDDR, as mentioned above, without any particular pulverization (for example, in the form of the raw material lumps). That is to say, the cast alloy after hydrogen decrepitation (the magnet raw material) does not need to be in powdery forms.

Of course, before supplied to HDDR, the magnet raw material (raw material powder) can be controlled in particle size by disintegration by slight force application, pulverization, classification, etc. in view of required specifications of magnet powder, production processes (facilities), and required specifications of a bonded magnet, etc. Preferably, particle size control is made, for example, to have an average particle diameter in the range of 30 to 200 μm. Although the average particle diameter is greatly affected by crystal grain diameters of a cast structure before hydrogen decrepitation, the magnet raw material after hydrogen decrepitation can be controlled to have a desired particle diameter by additional pulverization.

An average particle diameter in the present description (also referred to as “an average powder particle diameter”) is determined as follows. First, powder of −212 μm obtained by pulverization or sieving is used as a target. This powder is classified by sieving into 0 to 53 μm, 53 to 75 μm, 75 to 106 μm, 106 to 150 μm, and 150 to 212 μm. Then, a weight ratio (called “weight frequency”) of each of the sieved powders (y to x: μm) to the whole is measured. A product of an average particle size ((y+x)/2: μm) and weight frequency of each of the sieved powders is calculated. A total of these products is defined as “an average particle diameter” (an average powder particle diameter).

It is to be noted that expressions according to sieve classification (refer to JIS Z 8801) have the following meanings. −x μm: powder which passes through a sieve having openings of x μm (powder having a maximum diameter smaller than x μm), (+)y μm: powder which does not pass through a sieve having openings of y μm (powder having a minimum particle diameter greater than y μm), y to x μm: powder which passes through a sieve having openings of x μm and does not pass through a sieve having openings of y μm

Note that laser diffraction analysis of particle diameter was not conducted, because high pressure gas blown against a magnet raw material before analysis reduces particle diameters of the magnet raw material after hydrogen decrepitation and makes precise measurement impossible.

### Magnet Powder

Application of hydrogen treatment (HDDR) to the aforementioned magnet raw material (the raw material powder/the raw material lumps) after hydrogen decrepitation produces magnet powder comprising polycrystalline substance (magnet particles) in which fine R₂TM₁₄B₁ based crystals (average crystal grain diameter: 0.05 to 1 μm) aggregate.

(1) HDDR is roughly divided into a disproportionation step (HD) and a recombination step (DR). The disproportionation step is a step for causing a disproportionation reaction to a magnet raw material which is placed in a treatment furnace and has absorbed hydrogen by exposure to a predetermined hydrogen atmosphere. Examples of preferred conditions of the disproportionation step include hydrogen partial pressure: 10 to 300 kPA, atmosphere temperature: 600 to 900 deg. C, treatment time: 1 to 5 hours.

The recombination step is a step for desorbing hydrogen from the magnet raw material after the disproportionation step and causing a recombination reaction to the magnet raw material. Examples of preferred conditions of the recombination step include hydrogen partial pressure: 1 kPA or less, atmosphere temperature: 600 to 900 deg. C, treatment time: 1 to 5 hours.

(2) All or part of the HD step and the DR step can be performed as the following steps.

### (a) Low-Temperature Hydrogeneration Step

A low-temperature hydrogeneration step is a step of holding the magnet raw material in a hydrogen atmosphere having a temperature equal to or lower than a temperature causing a disproportionation reaction (e.g., room temperature to 300 deg. C or room temperature to 100 deg. C) in a treatment furnace. This step makes the magnet raw material absorb hydrogen beforehand and slows down disproportionation reaction rate of the following high-temperature hydrogeneration step (corresponding to the disproportionation step). This facilitates reaction rate control of forward structure transformation. Preferred hydrogen partial pressure in this step is, for example, about 30 to 100 kPa. As mentioned before, a hydrogen atmosphere in the present description can be a mixed gas atmosphere of hydrogen and an inert gas. (The same applies hereinafter.)

### (b) High-Temperature Hydrogeneration Step

A high-temperature hydrogeneration step is a step of holding the magnet raw material after the low-temperature hydrogeneration step in a hydrogen atmosphere having a hydrogen partial pressure of 10 to 60 kPa and a temperature of 750 to 860 deg. C. This step causes the magnet raw material after the low-temperature hydrogeneration step to make a disproportionation reaction (forward transformation reaction) and have a three-phase decomposed structure including aFe phase, RH₂ phase, and Fe₂B phase.

Hydrogen partial pressure or atmosphere temperature in this step does not need to be constant all the time. For example, reaction rate can be controlled by increasing at least one of hydrogen partial pressure and temperature in a closing part of this step when a reaction rate decreases, in order to promote three-phase decomposition (a structure stabilization step).

### (c) Controlled Evacuation Step

A controlled evacuation step is a step of holding the magnet raw material after the high-temperature hydrogeneration step in a hydrogen atmosphere having a hydrogen partial pressure of 0.7 to 6 kPa and a temperature of 750 to 850 deg. C. This step causes the magnet raw material after the high-temperature hydrogeneration step to make a recombination reaction (reverse transformation reaction) in association with hydrogen desorption. This removes hydrogen from the RH₂ phase in the three-phase decomposed structure and forms fine R₂TM₁₄B₁ based crystal hydrides (RFeBHₓ) whose crystal orientation has copied that of the Fe₂B phase. Since the recombination reaction in this step is made under a relatively high hydrogen partial pressure, the reaction proceeds slowly. If the high-temperature hydrogeneration step and the controlled evacuation step are carried out at approximately the same temperature, transition from the high-temperature hydrogeneration step to the controlled evacuation step can be easily conducted only by a change in hydrogen partial pressure.

### (d) Forced Evacuation Step

A forced evacuation step is preferably performed, for example, in a vacuum atmosphere of 1 Pa or less at 750 to 850 deg. C. This step removes hydrogen remaining in the magnet raw material and finishes hydrogen desorption.

The forced evacuation step and the controlled evacuation step do not have to be done successively. A cooling step for cooling the magnet raw material can be carried out after the controlled evacuation step and then the forced evacuation step can be executed in batch treatment. Cooling after the forced evacuation step is preferably rapid in order to suppress crystal grain growth.

(3) A diffusion treatment for increasing coercivity can be performed. The diffusion treatment can be done, for example, by heating a mixed material of the magnet raw material and a diffusion raw material. This forms a non-magnetic phase on surfaces or along grain boundaries of R₂TM₁₄B₁ based crystal, thereby improving coercivity of the magnet particles. The diffusion treatment can be conducted, for example, by separately heating a mixed powder of the magnet powder obtained after HDDR and diffusion raw material powder in a vacuum atmosphere or an inert gas atmosphere. If the magnet raw material and the diffusion raw material are mixed before any one of the low-temperature hydrogeneration step, the high-temperature hydrogeneration step, the controlled evacuation step, and the forced evacuation step, the following step also plays a role of diffusion treatment. Examples of the diffusion raw material include heavy rare earth elements (Dy, Tb, etc.), alloys or compounds (e.g., fluorides) of the heavy rare earth elements, alloys of light rare earth elements (e.g., Cu alloys, Cu—Al alloys) or compounds of the light rare earth elements.

### (4) Magnet Powder

Magnet powder obtained after HDDR (including d-HDDR), i.e., the rare-earth magnet powder after the recombination step also has an average particle diameter, for example, within the range of 30 to 200 μm, 50(over) to 190 μm, or 55 to 180 μm.

### INDUSTRIAL APPLICABILITY

The rare-earth magnet powder of the present invention can be used in a wide variety of fields, and its typical use is a bonded magnet. The bonded magnet mainly comprises rare-earth magnet powder and a binder resin. The binder resin can be either thermosetting resin or thermoplastic resin. The bonded magnet can be formed by compression molding or injection molding. The bonded magnet using the anisotropic rare-earth magnet powder can exhibit high magnetic properties when molded in an oriented magnetic field.

### EXAMPLES

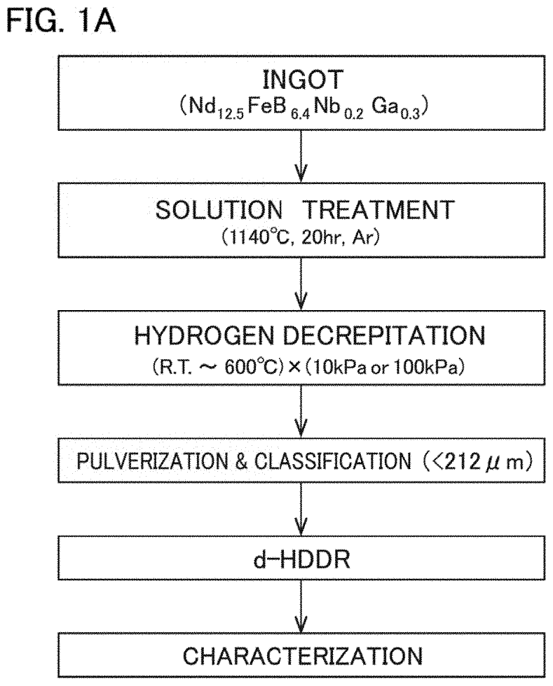

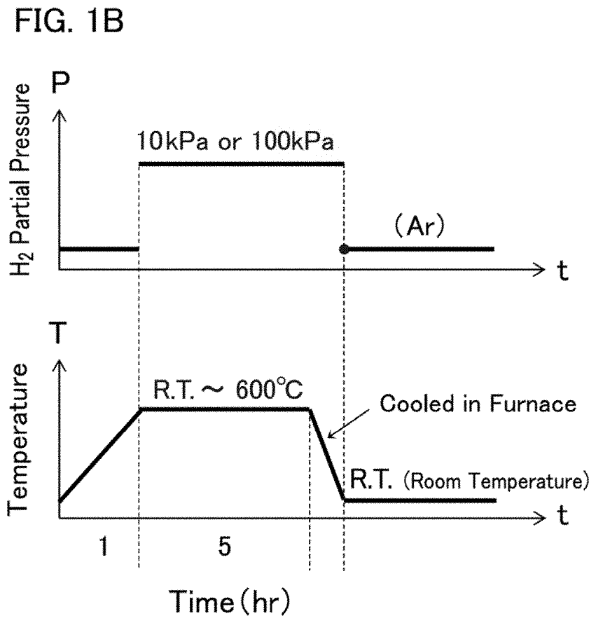

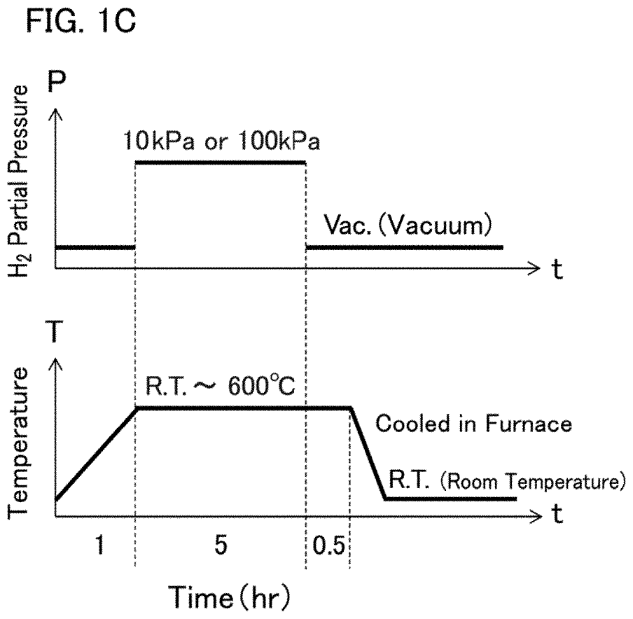

As shown in FIG. 1A, a variety of kinds of hydrogen decrepitation using different hydrogen atmospheres was applied to ingots (a cast alloy) subjected to solution treatment. Magnet raw materials after hydrogen decrepitation were lightly pulverized and classified by sieving. HDDR was applied to raw material powders thus obtained, thereby obtaining magnet powders. Then magnetic properties of the magnet powders were evaluated. Hereinafter, the present invention will be concretely discussed by way of such examples.

### Example 1

### Production of Specimens

### (1) Cast Alloy

A raw material weighed to have a desired alloy composition (Nd: 12.5 at. %, B: 6.4 at. %, Nb: 0.2 at. %, Ga: 0.3 at. %, Fe: remainder) was melted in a high frequency melting furnace, thereby obtaining casting products (a cast alloy).

### (2) Solution Treatment

The casting products were homogenized by heating in an Ar gas atmosphere at 1140 deg. C for 20 hours.

### (3) Hydrogen Decrepitation

The following hydrogen decrepitation was applied to the casting products after the solution treatment. First, a treatment furnace in which each of the casting products was placed was evacuated to a vacuum of 10⁻² Pa or less. Then, while kept in vacuum, the treatment furnace was heated. As shown in FIG. 1B, in one hour, an inside of the treatment furnace reached a desired atmosphere temperature. Then hydrogen was introduced into the treatment furnace to reach a desired hydrogen partial pressure. This state was kept for 5 hours (a hydrogen absorption step). At this time, hydrogen partial pressure was 10 kPa or 100 kPa, and atmosphere temperature was any of room temperature (R. T.) to 600 deg. C. The atmosphere temperature in the treatment furnace was measured by a thermocouple contacted to each of the casting products, and the hydrogen partial pressure was measured by a pressure gauge installed in the treatment furnace.

Subsequently, each of the casting products was cooled to room temperature in the treatment furnace while keeping the hydrogen partial pressure as it was. Hydrogen in the treatment furnace was replaced with an inert gas (Ar under atmospheric pressure), and each magnet raw material after hydrogen decrepitation treatment was removed from the treatment furnace having the Ar atmosphere. Slight force for disintegration was applied to the magnet raw materials treated at atmosphere temperatures of R. T. to 500 deg. C. Since the magnet raw materials treated at atmosphere temperatures of 550 deg. C or 600 deg. C were hardly disintegrated into powder by merely slight force application, those magnet raw materials were mechanically pulverized. Powders thus obtained were classified by sieving, thereby obtaining raw material powders of −212 μm. This pulverization and classification by sieving were conducted in an inert gas atmosphere.

Note that hydrogen decrepitation treatment can be applied in the pattern shown in FIG. 1C instead of the pattern shown in FIG. 1B. In the pattern of FIG. 1C, 0.5 hour (30 minutes) after the hydrogen absorption step finishes and hydrogen in the treatment furnace is evacuated, each magnet raw material is cooled down to room temperature. Other conditions are the same as those of the pattern of FIG. 1B. It was confirmed that magnet powders having similar properties can be obtained by using magnet raw materials treated in the pattern of FIG. 1C, and by using magnet raw materials treated in the pattern of FIG. 1B.

### (4) HDDR Treatment

A treatment furnace in which 15 g of each of the raw material powders subjected to hydrogen decrepitation at different temperatures was placed was evacuated into vacuum. HDDR treatment was applied to each of the raw material powders by controlling hydrogen partial pressure and temperature in the treatment furnace. Specifically, a disproportionation reaction (forward transformation reaction) was caused to each of the raw material powders by a high-temperature hydrogeneration step (820 deg. C, 30 kPa, 3 hours) (a disproportionation step).

Next, a controlled evacuation step of continuously evacuating hydrogen from the treatment furnace (820 deg. C, 5 to 1 kPa, 1.5 hours) and a forced evacuation step (820 deg. C, 10⁻² Pa, 0.5 hour) were carried out in succession. Thus, a recombination reaction (reverse transformation reaction) was caused to each of the raw material powders (a recombination step). Subsequently, each of the treated materials was rapidly cooled in the treatment furnace by introducing Ar gas (a cooling step). Each of the treated materials was disintegrated by slight force application in the Ar gas and then classified by sieving, thereby obtaining each magnet powder of −212 μm in particle diameter.

### Observation

### (1) Magnet Raw Materials After Hydrogen Decrepitation

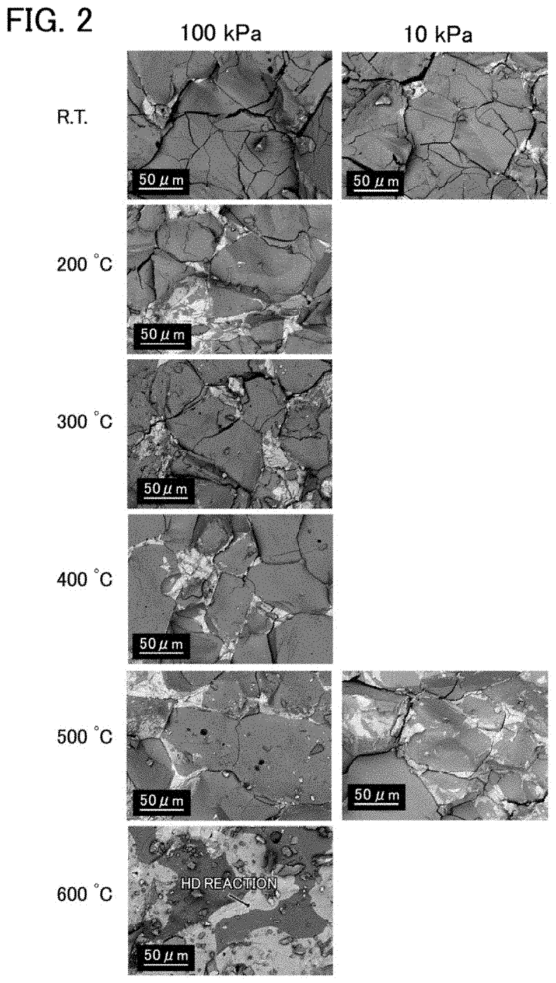

Magnet raw materials (raw material lumps) as they were obtained by applying hydrogen decrepitation under a variety of conditions to the casting products were observed with a scanning electron microscope (SEM) and images are comparatively shown in FIG. 2.

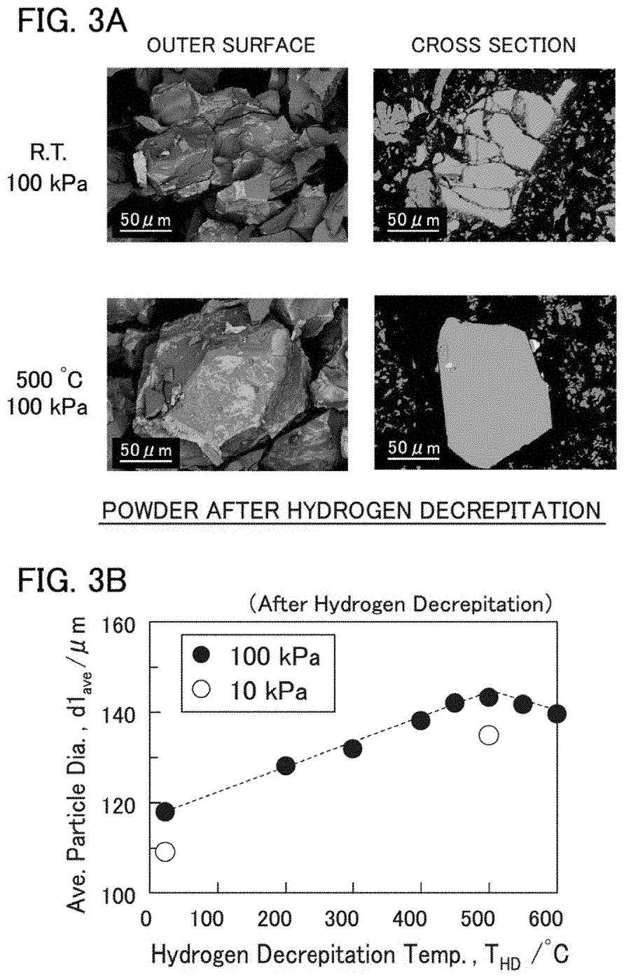

The raw material lumps subjected to hydrogen decrepitation treatment using hydrogen atmospheres in the treatment furnace under a combination of room temperature (R.T.) and 100 kPa or a combination of 500 deg. C and 100 kPa were pulverized (“pulverize” herein includes the meaning of “disintegrate”). Particles of thus obtained raw material powders were observed with the SEM. Outer surfaces and cross sections of the particles are shown in FIG. 3A.

### (2) Magnet Powder After HDDR

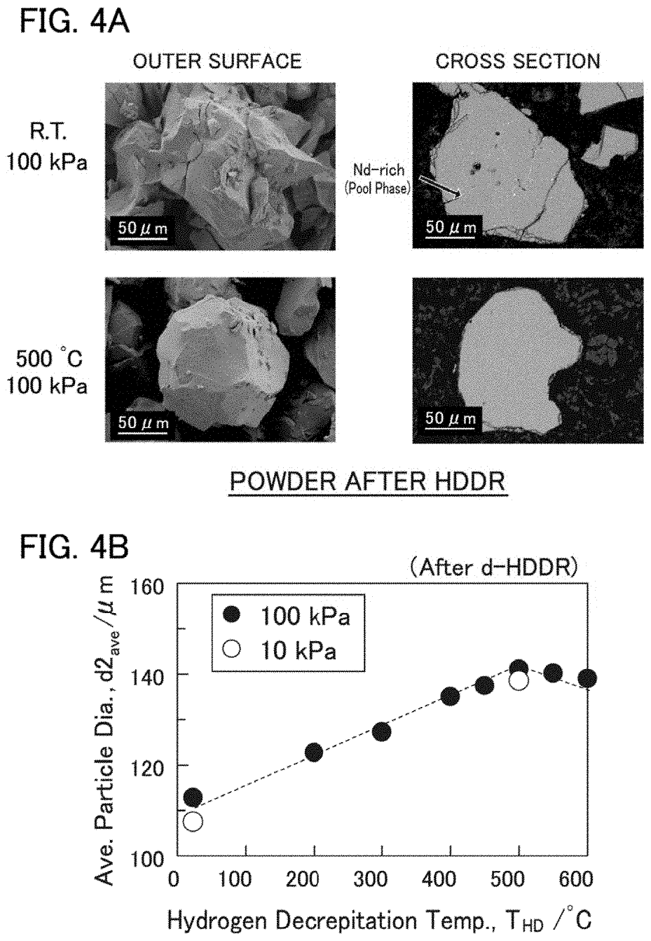

HDDR was applied under the same conditions to the raw material powders subjected to hydrogen decrepitation at the different atmosphere temperatures (the different hydrogen decrepitation temperatures). Particles of magnet powders thus obtained were observed with the SEM. Outer surfaces and cross sections of the particles are shown in FIG. 4A.

### Measurement

### (1) Average Particle Diameter

Average particle diameters of the raw material powders obtained by pulverizing the magnet raw materials after applying hydrogen decrepitation in different atmospheres are shown in FIG. 3B. In addition, average particle diameters of the magnet powders obtained by applying HDDR under the same conditions to those raw material powders are shown in FIG. 4B. Average particle diameter measurement was performed on powders of −212 μm obtained by classification by sieving. The average particle diameters were calculated according to the aforementioned method.

### (2) Magnetic Properties

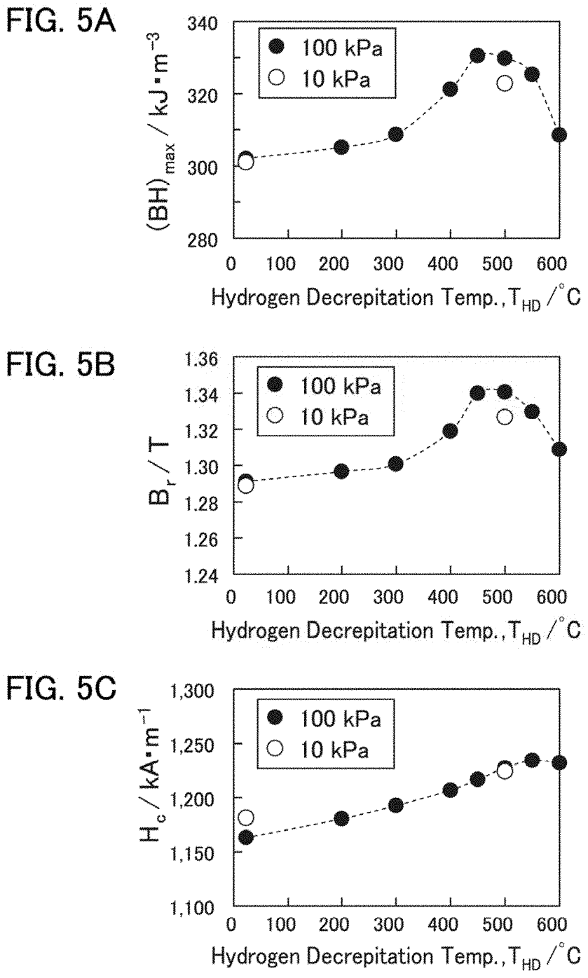

Magnetic properties were analyzed in the following manner on the magnet powders obtained by applying HDDR under the same conditions to the raw material powders treated under different hydrogen decrepitation conditions. The magnet powders were respectively packed in capsules and oriented in a magnetic field of 1193 kA/m in molten paraffin (about 80 deg. C), and then magnetized at 3,580 kA/m. Magnetic properties of the magnet powders after magnetization were analyzed by a vibrating sample magnetometer (VSM). In this case, density of each of the magnet powders was assumed as 7.5 g/cm³. Maximum energy product ((BH)ₘₐₓ), residual magnetic flux density (Bᵣ) and coercivity (H_{c}) of the magnet powders thus obtained are shown in FIGS. 5A, 5B, and 5C (collectively and simply referred to as FIG. 5), respectively.

### Evaluation

### (1) Magnet Raw Material

As is apparent from FIG. 2, when hydrogen decrepitation was applied in a hydrogen atmosphere in a room temperature range as in a conventional case, a variety of sizes of cracks occurred in a great number both along a grain boundary phase and in a main phase.

On the other hand, as the atmosphere temperature used in hydrogen decrepitation (referred to as hydrogen decrepitation temperature (T_{HD})) increased, the number of cracks decreased. It was found that this tendency is hardly affected by hydrogen partial pressure and mainly depends on hydrogen decrepitation temperature. However, it is estimated that when the atmosphere temperature used in hydrogen decrepitation was 600 deg. C, a disproportionation reaction (HD reaction) and melting of a R-rich phase (Nd-rich phase) occurred partially.

When the hydrogen decrepitation temperature was 400 to 500 deg. C, fine cracks remarkably decreased and cracks occurred mainly along the grain boundary phase and were hardly observed in the main phase. This is also supported by the SEM images shown in FIG. 3A. Besides, this tendency is reflected in average particle diameters shown in FIG. 3B.

### (2) Magnet Powder

As is clear from a comparison between FIG. 3A and FIG. 3B (collectively and simply referred to as “FIG. 3”) and FIG. 4A and FIG. 4B (collectively and simply referred to as “FIG. 4”), forms of particles after HDDR mostly reflect forms of particles after hydrogen decrepitation. As is apparent from FIGS. 5, magnetic properties of the magnet powders (of Example 1) increased with hydrogen decrepitation temperature, and Bᵣ and (BH)ₘₐₓ exhibited their peaks when the hydrogen decrepitation temperature was 450 to 500 deg. C. If attention is focused on (BH)ₘₐₓ as a comprehensive index of magnetic properties, it is clear that hydrogen decrepitation temperature is preferably 350 to 585 deg. C, 400 to 575 deg. C or 425 to 550 deg. C. Note that the magnet powders of Example 1 had degrees of texture (DOT) of 0.69 to 0.73.

### Discussions

It is clear from the above that magnet powder having higher magnetic properties than the conventional can be obtained by applying HDDR to a magnet raw material (raw material powder) subjected to hydrogen decrepitation in a predetermined temperature range. Although not all clear, the reason is assumed so far as follows.

### (1) Crack Density

In order to investigate the aforementioned reason, density of cracks in the raw material lumps obtained respectively by applying hydrogen decrepitation treatment in different atmospheres to the aforementioned casting products after solution treatment was calculated. Crack density is an index of whether crystal grains after hydrogen decrepitation are easy to crack in the grains (in the main phase) or not, etc.

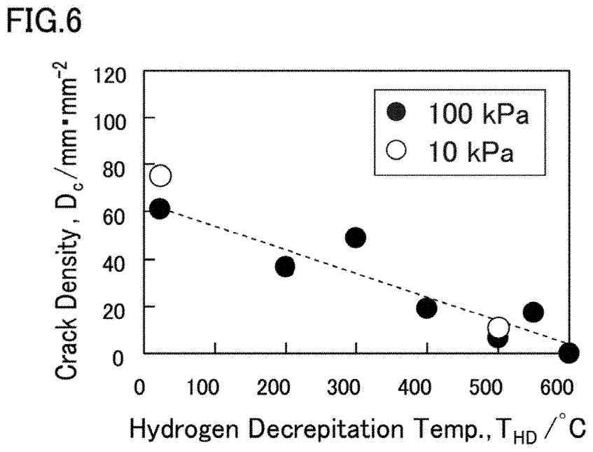

Crack density was calculated as follows. The respective raw material clumps were observed with a field emission scanning electron microscopy (FE-SEM). SEM images of the respective raw material clumps were processed by an image processing software so as to obtain a total length of cracks in crystal grains (a main phase) (called “transgranular crack length”) in a certain field of view. Crack density was obtained by dividing the total length with area of the certain field of view. Results are shown in FIG. 6. Length of crystal grain boundaries was excluded from the total length of cracks on the presumption that crystal grain boundaries are cracked.

As is apparent from FIG. 6, crack density monotonously decreases with an increase in hydrogen decrepitation temperature. It is to be noted that when the hydrogen decrepitation temperature was 600 deg. C, not only transgranular cracks but also intergranular cracks were not observed due to a HD reaction (hydrogeneration and disproportionation reaction).

### (2) Mechanism

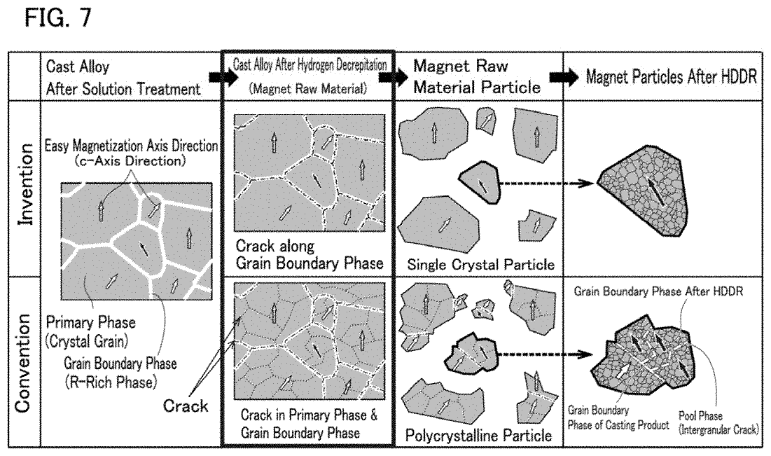

Considering FIG. 2, FIG. 3A, FIG. 4A and FIG. 6, a mechanism of how the production method of the present invention can produce magnet powder having higher magnetic properties than the conventional is believed as follows. Summary is schematically shown in FIG. 7.

First, a cast alloy (a casting product) after a solution treatment comprises a main phase and a grain boundary phase surrounding the main phase, as shown in FIG. 7. When the cast alloy is a typical Nd—Fe—B based magnet alloy, the main phase is a Nd₂Fe₁₄B phase and the grain boundary phase is a Nd-rich phase (R-rich phase).

When hydrogen decrepitation temperature is low as in conventional methods, hydrogen penetrates not only into the grain boundary phase but also into the main phase and makes cracks in the cast alloy after hydrogen decrepitation (a magnet raw material, raw material lumps). Pulverization (including disintegration) of the raw material clumps forms magnet raw material particles which are fractured along some cracks inside and outside of the main phase. This state is confirmed from the upper photographs in FIG. 3A, which show that each of the particles has a plurality of projections formed by brittle fracture inside crystal grains.

Each of such magnet raw material particles is a mixture of a plurality of crystal grains (main phase) having different easy axis directions of magnetization (the arrows in FIG. 7). This state is inherited by magnet particles after HDDR. This is believed to result in that application of HDDR to a magnet raw material subjected to hydrogen decrepitation at a low temperature did not produce magnet powder having high magnetic properties (especially Bᵣ).

On the other hand, when hydrogen decrepitation temperature is high as in the present invention, hydrogen mainly penetrates into the grain boundary phase and hardly penetrates into the main phase and makes cracks mainly along the crystal boundary phase in the cast alloy after hydrogen decrepitation (raw material clumps). Pulverization of the raw material clumps forms magnet raw material particles fractured along the grain boundary phase formed in casting. This state is confirmed by the lower photographs in FIG. 3A.

Each of such magnet raw material particles mainly comprises single crystal grains (the main phase) and their easy axes of magnetization are aligned with each other. This state is inherited by each magnet particle after HDDR. This is believed to result in that application of HDDR to a magnet raw material subjected to hydrogen decrepitation at a high temperature produced magnet powder having high magnetic properties (especially Bᵣ/FIG. 5B).

Moreover, when HDDR is applied to magnet raw material particles having transgranular cracks as in the conventional case, a grain boundary phase, not shown, which used to be a grain boundary phase (Nd-rich phase/R-rich phase: white thick solid line portions in the lower rightmost of FIG. 7) of a cast product and was present on surfaces of the magnet raw material particles is melted and penetrates into transgranular cracks (white thick dashed line portions in the lower rightmost of FIG. 7) and forms a pool phase (Nd-rich phase/R-rich phase). Due to volume of the pool phase, a sufficient grain boundary phase (Nd-rich phase/R-rich phase: the thin black line portions in the lower rightmost of FIG. 7) is hardly formed between fine crystal grains formed after HDDR. This is believed to be how application of HDDR to a magnet material subjected to hydrogen decrepitation at a low temperature did not produce magnet powder having high magnetic properties (especially H_{c}/FIG. 5C).

On the other hand, when HDDR is applied to magnet raw material particles having few transgranular cracks as in the present invention, without wastefully pooled, a sufficient grain boundary phase (Nd-rich phase/R-rich phase: black thin line portions in the upper rightmost of FIG. 7) is formed between fine crystal grains after HDDR. This is believed to be how application of HDDR to a magnet raw material subjected to hydrogen decrepitation at a high temperature produced magnet powder having high magnetic properties (especially H_{c}/FIG. 5C).

As is seen from a comparison of FIG. 5A, FIG. 5B and FIG. 6, Bᵣ or (BH)ₘₐₓ of magnet powders showed a decrease tendency in a hydrogen decrepitation temperature range (550 to 600 deg. C) after showing its peak in spite of a decrease in crack density. The reason is assumed as follows.

The casting products (the magnet raw material) subjected to hydrogen treatment at 550 deg. C or 600 deg. C were not disintegrated into powder by slight force application and mechanically pulverized into raw material powder having a predetermined particle size before supplied to HDDR, as mentioned before. The reason why such pulverization was necessary is believed to be that, as is seen from a photograph shown in FIG. 2, when the casting products were subjected to hydrogen treatment at 550 deg. C or 600 deg. C, few cracks occurred either in the crystal grains or along the grain boundaries and, therefore, the casting products were hard to be broken down.

Since a considerably greater force is applied in the mechanical pulverization than slight force applied for disintegration, the casting products subjected to hydrogen treatment get cracks which penetrate crystal grains. As a result, polycrystalline particles (see FIG. 7) increase again in the raw material powders to be supplied to HDDR. This is believed to cause a decrease from its peak of Bᵣ or (BH)ₘₐₓ of the magnet powders obtained from the magnet raw materials treated at a hydrogen decrepitation temperature of 550 deg. C or 600 deg. C.

### Example 2

(1) Hydrogen decrepitation and HDDR treatment were applied to casting products which were subjected to R-rich dispersion treatment after solution treatment (before hydrogen decrepitation). Production steps except the R-rich dispersion treatment were the same as those of Example 1. The R-rich dispersion treatment was performed as follows.

A treatment furnace in which each casting product after solution treatment was placed was evacuated to a vacuum of 10⁻² Pa or less. While kept in vacuum, the treatment furnace was heated. In one hour, an inside of the treatment furnace (hydrogen partial pressure: 10⁻² Pa or less) reached an atmosphere temperature of any one of 500 to 900 deg. C. This state was held for one hour (a R-rich dispersion treatment step). Subsequently, the vacuum atmosphere was changed in a predetermined length of time to a hydrogen decrepitation treatment atmosphere (500 deg. C, 100 kPa).

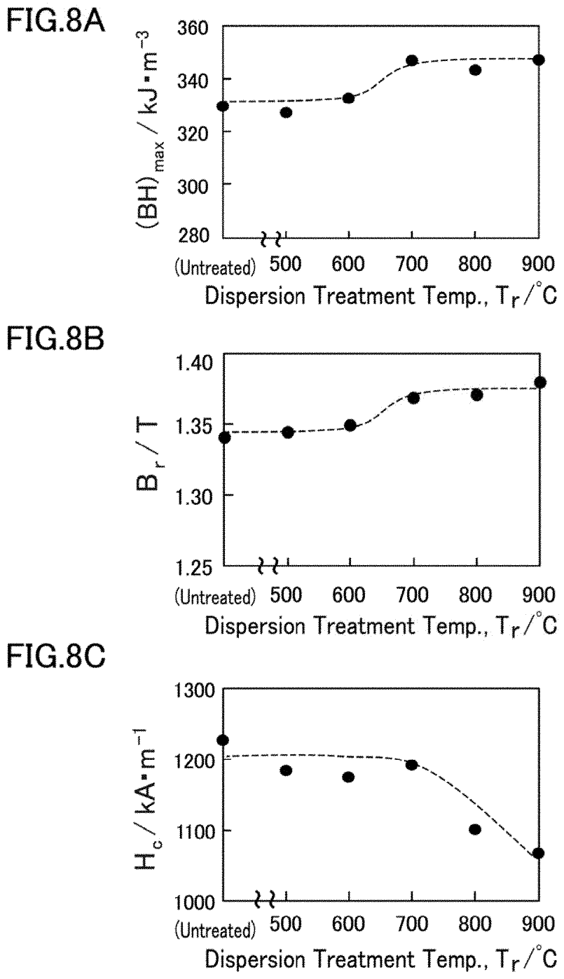

(2) Relations between treatment temperature of R-rich dispersion treatment (referred to as “dispersion treatment temperature Tᵣ”) and magnetic properties ((BH)ₘₐₓ, Bᵣ, H_{c}) of magnet powders thus obtained are shown in FIG. 8A to FIG. 8C (collectively and simply referred to as FIG. 8). The magnetic properties were measured by the aforementioned methods. The word “untreated” in FIG. 8 indicate magnet powder, corresponding to that of Example 1, obtained by applying hydrogen decrepitation (500 deg. C, 100 kPa) to a casting product which was not subjected to the R-rich dispersion treatment.

As is apparent from FIG. 8, application of R-rich dispersion treatment further improves magnetic properties. Especially when dispersion treatment temperature was higher than 600 deg. C or equal or higher than 650 deg. C, (BH)ₘₐₓ or Bᵣ improved remarkably. This tendency did not change even when the dispersion treatment temperature was 900 deg. C. However, when the dispersion treatment temperature exceeded 750 deg. C, H_{c} showed a decrease tendency. When magnet powder having high coercivity is needed, preferably the dispersion treatment temperature is 750 deg. C or less or 720 deg. C or less. Note that magnet powder obtained by treated at a dispersion treatment temperature of 700 deg. C had a degree of texture (DOT) of 0.76.

### Example 3

(1) Magnet powders (Specimens 31, 32) were produced by applying hydrogen decrepitation (hydrogen partial pressure: 100 kPa, atmosphere temperature: 500 deg. C, holding time: 5 hours) to magnet raw materials and then applying HDDR treatment in succession without removing the magnet raw materials from a treatment furnace where hydrogen decrepitation was carried out. In this case, vacuum evacuation before HDDR treatment as in Example 1 was not performed. Mechanical pulverization and classification by sieving were conducted not after hydrogen decrepitation but after HDDR treatment. Production steps other than these were similar to those of Example 1.

Specimen 31 is magnet powder obtained by applying HDDR treatment to a magnet raw material which was cooled to room temperature after hydrogen decrepitation in the treatment furnace while keeping hydrogen partial pressure at 100 kPa. Specimen 32 is magnet powder obtained by shifting treatments from hydrogen decrepitation to HDDR by controlling an atmosphere in the treatment furnace without cooling a magnet raw material after hydrogen decrepitation in the treatment furnace. In addition, magnet powder (Specimen C) was also produced by changing the atmosphere temperature of hydrogen decrepitation of Specimen 31 to room temperature (23 deg. C).

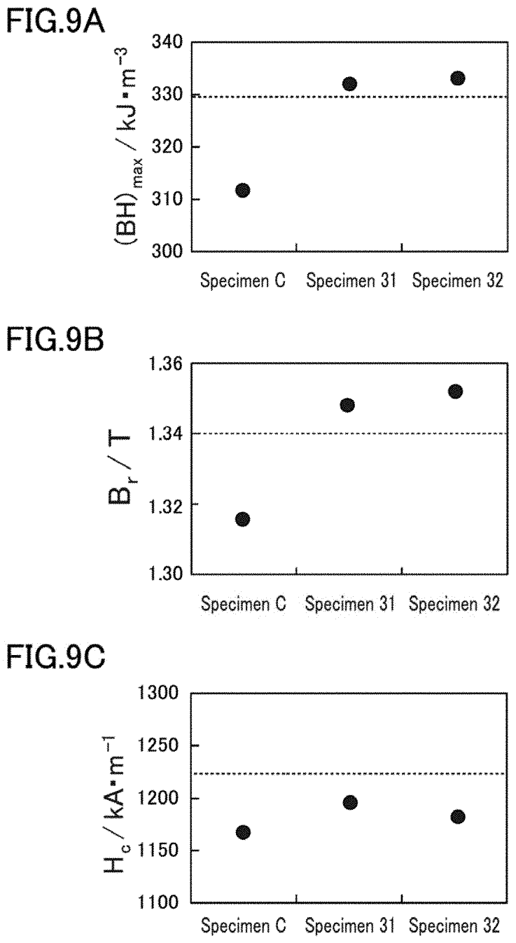

(2) Magnetic properties ((BH)ₘₐₓ, Bᵣ, H_{c}) of the magnet powders of the specimens are shown in FIG. 9A to FIG. 9C (collectively and simply referred to as FIG. 9). The magnetic properties were measured by the aforementioned methods. Note that broken lines in FIG. 9 show magnetic properties of magnet powder, corresponding to that of Example 1, obtained by applying hydrogen decrepitation under the same conditions (500 deg., 100 kPa).

As is apparent from FIG. 9, magnet powders having high magnetic properties (especially Bᵣ, (BH)ₘₐₓ) can be obtained by applying HDDR in succession to hydrogen decrepitation, as well as in Example 1. Note that the magnet powders of Specimens 31, 32 had degrees of texture (DOT) of 0.71 to 0.74.

1. A method for producing rare-earth magnet powder, comprising:
a disproportionation step of causing hydrogen absorption and disproportionation reaction to a magnet raw material obtained by exposing a cast alloy containing a rare earth element (referred to as “R”), boron (B) and a transition metal (referred to as “TM”) to a hydrogen atmosphere having a temperature within the range of 350 to 585 deg. C; and
a recombination step of causing hydrogen desorption and recombination reaction to the magnet raw material after the disproportionation step.

2. The method for producing rare-earth magnet powder according to claim 1, wherein the hydrogen atmosphere has a hydrogen partial pressure within the range of 1 to 250 kPa.

3. The method for producing rare-earth magnet powder according to claim 1, wherein the cast alloy is a casting product subjected to a solution treatment.

4. The method for producing rare-earth magnet powder according to claim 1, wherein the cast alloy contains 11 to 15 at. % R and 5 to 9 at. % B when a total weight of the cast alloy is taken as 100 at. %.
